(19) United States
(12) Patent Application Publication
(10) Pub. No.: US 2023/0329515 A1
(43) Pub. Date: Oct. 19, 2023

(54) Foam Cotton Mop Head, a Mop Thereof, and a Manufacture Method Thereof

(71) Applicant: Huaihua Shuxiaofu New Material Technology Co., Ltd., Huaihua City (CN)

(72) Inventors: Min He, Ningbo City (CN); Jian Wu, Ningbo City (CN); Jun Shu, Ningbo City (CN)

(21) Appl. No.: 18/297,167

(22) Filed: Apr. 7, 2023

(30) Foreign Application Priority Data
Apr. 18, 2022 (CN) 202220910329.1
Feb. 23, 2023 (CN) 202310181798.3

(51) Int. Cl. A47L 13/257; B29C 44/12

(52) U.S. Cl. CPC A47L 13/257; B29C 44/1214; B29C 44/1271; B29K 2075/00

(57) ABSTRACT

A foamed cotton mop head has a mounting member (1) having a joint portion (11) mounted on a mounting plate (12) extending downward and a foamed cotton head (2) mounted on the mounting member (1); wherein, the mounting plate (12) is inserted downward into the top of the foamed cotton head (2) and attached to the foamed cotton head (2), forming a framework for the foamed cotton head (2). The whole foam cotton head (2) is partially supported by the mounting plate (12), so that the foamed cotton head (2) is kept at certain strength, not floppy, and difficult to shake and deform during mopping. The mopping operation becomes easier, and the hand feeling is better. During the water squeezing, it is ensured that the surface of the foamed cotton head are subjected to the squeezing force evenly and difficult to deform. In addition, it is easier for the foamed cotton head to pass through the elastic bayonet of the water squeezing frame.

### TECHNICAL FIELD OF THE INVENTION

The present invention relates to the field of a foamed cotton mop head, where the foamed cotton can be collodion cotton, sponge or the like. The present invention also relates to a foamed cotton mop, and a method for manufacturing a mop head.

### BACKGROUND OF THE INVENTION

Conventional collodion cotton mops are of roughly the same structure, including a mop rod, a mop head and a water-squeezing mechanism. The water squeezing device in the collodion cotton mop is a transmission structure, and the water squeezing device includes a pull handle, a pull rod, a caliper seat (squeezing frame), a collodion cotton clamp and a water squeezing rod, wherein the caliper seat is roughly U-shaped; the collodion cotton is clamped by the collodion cotton clamp; the collodion cotton clamp is fixed at the bottom of the pull rod, while the top end of the pull rod is in movable pin connection to the middle portion of pull handle; the rear end of the pull handle is in pin connected to the mop rod; and, the water squeezing rods are oblate, and two ends of the water squeezing rods are in pin connection to the bottom of the caliper seat. During a water-squeezing operation, the pull handle is pulled to drive the collodion cotton to move up horizontally through the pull rod, and the collodion cotton passes between the water squeezing rods of the squeezing frame. Since the water squeezing rods have the elasticity for keeping the clamping trend, the collodion cotton passing through the water squeezing rods will be clamped by the water squeezing rods to realize water squeezing. After searching, a Chinese patent CN2626415Y (patent No.: ZL03231227.X) titled “Collodion Cotton Mop”, a Chinese patent CN201409887Y (patent No.: ZL200920121093.8) titled “An Inserting-type Water Squeezing Collodion Cotton Mop”, a Chinese patent CN201453183U (patent No.: ZL200920075021.4) titled “A Collodion Cotton Mop” and a Chinese patent CN102138771A (patent No.: ZL201110102067.2) titled “A Movable Multifunctional Collodion Cotton Mop” were found. These patents all disclosed a water-squeezing device for a collodion cotton mop.

The mop head for the above-mentioned mop comprises a piece of collodion cotton and a clamp clamped at the top of the collodion cotton. The whole collodion cotton has a certain thickness and a roughly circular cross-section. The collodion cotton disposed under the frame is floppy and easy to shake when mopping the floor because it is soft, resulting in poor mopping feeling. In addition, during the water squeezing, the floppy collodion cotton will lead to an uneven squeezing force applied on the surface of the collodion cotton when pushing the water squeezing rods, resulting in poor water squeezing effect and hand feeling. Furthermore, the floppy collodion cotton is easy to deform, for example, being inclined and distorted to one side, so that the user experience is affected.

In conclusion, the existing collodion cotton mops have much space for improvement.

### SUMMARY OF THE INVENTION

It is a first object of the present invention to provide a foamed cotton mop head which is reasonable in structure and good in the quality of its foamed cotton.

For achieving the first object, the foamed cotton mop head comprises a mounting member having a joint portion mounted on a mounting plate extending downward; a foamed cotton head mounted on the mounting member; wherein, the mounting plate is inserted downward into the top of the foamed cotton head and attached to the foamed cotton head, forming a framework for the foamed cotton head.

Preferably, the mounting plate is directly attached to the foam cotton head. In this way, it is the most convenient to connect the foamed cotton head and the mounting member as a whole, better for mass production, and the foamed cotton head and the mounting plate are attached firmly.

Preferably, the mounting plate has a plurality of through holes running transversely, or a plurality of recesses formed on the surface of the mounting plate, so that the foamed cotton can enter the through holes or the recesses, making the foamed cotton head and the mounting plate be attached more firmly.

Preferably, the foamed cotton head has an insertion slot extending downward from the top of the foamed cotton head; the mounting plate is inserted into the insertion slot and adhesively connected to the foamed cotton head. In this way, the structure of a foaming die can be simplified, but the operation is relatively complex.

Preferably, two sides of the foam cotton head are folded upward from the bottom of the mounting portion and extend to the surface of the mounting plate to be adhesively connected with each other. The adhesion of the structure is relatively complex.

Preferably, the mounting plate has a flange extending transversely from the top of the mounting plate, the mounting plate has a T-shaped cross-section; the joint portion, as an insertion joint, is connected to the middle of the flange and extends upward from the top of the flange. With the flange portion, the surface of the mop is increased, and the joint portion is ensured to have a larger cross-section area, enhancing the strength of the joint portion and the whole mop head.

To facilitate the connection between the joint portion and the mop rod, preferably, the joint portion is hollow, and has an elastic clamping pin on each of left and right sides. With this design, the joint portion can be inserted downward into and connected to the bottom of the mop rod in an elastically buckling manner. Preferably, the joint portion is oblate. After the oblate joint portion attaching to the mop rod, it is difficult for the joint portion and the mop rod to rotate relative to each other.

Preferably, the foam cotton head has two strip-shaped slopes on the top of the foam cotton head, which are respectively located on the two sides of the mounting portion, and, after the water squeezing frame is moved down, the water squeezing rod squeezes the foamed cotton head downward along the slopes. The slopes have a guiding function for the mop head to pass through the elastic bayonet, so that the water squeezing operation is easier, better for water squeezing.

Compared with the prior art, the foamed cotton mop head of the present invention has the following advantages. The mounting plate is inserted downward into the top of the foamed cotton head and attached to the foamed cotton head, forming a framework for the foamed cotton head. Thus, the whole foamed cotton head is partially supported by the mounting plate, so that the foamed cotton head is kept at certain strength, not floppy, and difficult to shake and deform during mopping. The mopping operation becomes easier, and the hand feeling is better. During the water squeezing, it is ensured that the surface of the foamed cotton head are subjected to the squeezing force evenly and difficult to deform. In addition, the connecting area between the foamed cotton and the mounting plate is larger, and it is difficult for the foamed cotton to separate from the mounting member when in use.

It is a second object of the present invention to provide a mop which has better mopping effect, better hand feeling, and more even squeezing force.

For achieving the second object, the mop comprises a mop rod and the above said foamed cotton mop head; wherein, the bottom of the mop rod is connected to the joint portion.

To assemble the foamed cotton mop head with the mop rod conveniently, preferably, the joint portion is detachably inserted into and connected to the bottom of the mop rod.

Compared with the prior art, the mop of the present invention has the following advantages. The whole foamed cotton head is partially supported by the mounting plate, so that the foamed cotton head is kept at certain strength, not floppy, and difficult to shake and deform during mopping. The mopping operation becomes easier, and the hand feeling is better. During the water squeezing, it is ensured that the surface of the foamed cotton head are subjected to the squeezing force evenly and difficult to deform. In addition, it is easier for the foamed cotton head to pass through the elastic bayonet of the water squeezing frame.

It is a third object of the present invention to provide a method of manufacturing the foamed cotton mop head, which is reasonable in manufacturing steps and has high manufacturing efficiency.

For achieving the third object, the method of manufacturing the foamed cotton mop head comprises the following steps:
step-1, manufacturing the above said mounting member;
step-2, placing the mounting member in a foaming die as an insert, and pouring a polyurethane solution into the foaming die and letting it stand, and then the polyurethane solution is foamed in the foaming die to wrap the exterior of the mounting plate of the mounting member to form a foamed cotton head.

Preferably, the foaming die comprises an upper die with an upper cavity and a lower die with a lower cavity; the lower cavity has a lower-half receiving chamber for receiving the joint portion and a lower foaming chamber for foaming; the upper cavity has an upper-half receiving chamber for receiving the joint portion and an upper foaming chamber for foaming; after the upper die and the lower die are closed, the joint portion is positioned within the space enclosed by the lower-half receiving chamber and the upper-half receiving chamber, and the mounting plate is located in the middle of the space enclosed by the lower foaming chamber and the upper foaming chamber. The structure of foaming die is very simple, accordingly, complex instruments are not needed in the forming process, and the processing cost is low.

Preferably, the detail operation of the foaming in the step-2 is as follows: pouring the polyurethane solution into the lower foaming chamber and placing the mounting member in the lower cavity, and then closing the upper die and letting it stand at last.

Preferably, the upper die/the lower die has a pouring channel communicated with the upper foaming chamber/the lower forming chamber; the detail operation of the foaming in the step-2 is as follows: placing the mounting member in the lower cavity and close the upper die and the lower die, and then pouring the polyurethane solution into the upper foaming chamber/the lower forming chamber through the pouring channel, and finally letting it stand and foam.

Preferably, the mounting member in the step-1 is: a plastic member which is manufactured by an injection molding machine. In this way, the mounting member is low in cost, benefit for mass production, and is difficult to rust. Of course, the mounting member may also be a metal member formed by stamping, or a cast formed by casting.

Compared with the prior art, the method of manufacturing a mop head of the present invention has the following advantages. The mounting member is placed in the foaming die as an insert, and the polyurethane solution poured into the die is foamed in the die. The formed cotton head after foaming is wrapped with the mounting member to form one integrated mass finally, therefore the foamed cotton head and the mounting member are attached with each other very firmly, and the foamed cotton head is difficult to separate from the mounting member when in use. The conventional way of making the foamed cotton head attached to the mounting member by adhesion is discarded, and the use of glue is avoided. The foamed cotton mop head manufactured by this method is more environment-friendly, it avoids the damage to the human body caused by the use of glue. In addition, the manufacturing process is simpler, it is advantageous for mass production, and the cost is reduced.

### BRIEF DESCRIPTION OF THE DRAWINGS

FIG. 1 is a first perspective view of a foamed cotton mop head according to the Embodiment 1 of the foamed cotton mop head of the present invention;

FIG. 2 is a second perspective view of the foamed cotton mop head according to Embodiment 1 of the foamed cotton mop head of the present invention;

FIG. 3 is an exploded view of the foamed cotton mop head according to Embodiment 1 of the foamed cotton mop head of the present invention;

FIG. 4 is a perspective view of a foamed cotton mop head according to Embodiment 2 of the foamed cotton mop head of the present invention;

FIG. 5 is an exploded view of a foamed cotton mop head according to Embodiment 2 of the foamed cotton mop head of the present invention;

FIG. 6 is a perspective view of a mop according to an embodiment of the present invention;

FIG. 7 is an exploded view of the mop according to the embodiment of the present invention;

FIG. 8 is a perspective view of a foaming die according to the embodiment of a method of manufacturing a mop head of the present invention;

FIG. 9 is a sectional view of the foaming die having the mounting member placed therein according to the embodiment of method of the present invention;

FIG. 10 is a perspective view of an upper die according to the embodiment of method of the present invention.

### DETAILED DESCRIPTION OF THE INVENTION

The present invention will be further described below in detail by embodiments with reference to the accompanying drawings.

### Embodiment 1 of the Foamed Cotton Mop Head

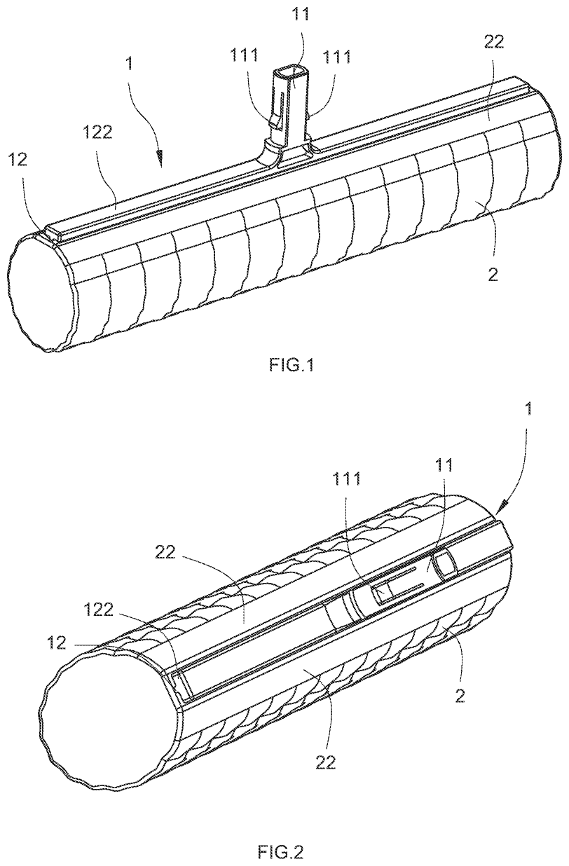

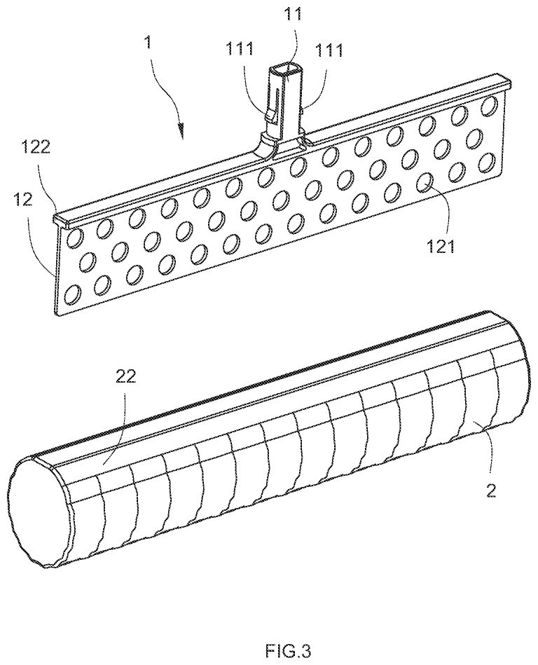

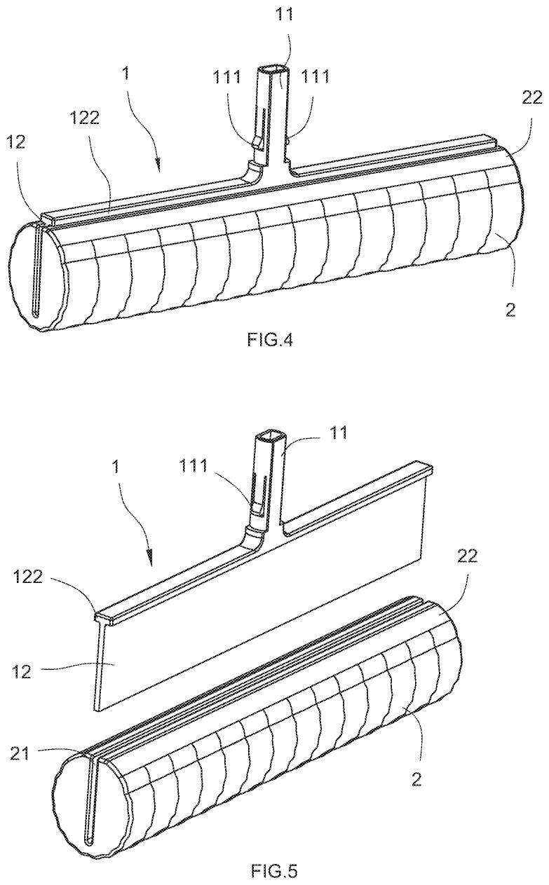

FIGS. 1-3 show a preferred Embodiment 1 of the foamed cotton mop head of the present invention. The foamed cotton mop head comprises a mounting member 1 and a foamed cotton head 2 mounted on the mounting member 1. The mounting member 1 has a joint portion 11 mounted on a mounting plate 12 extending downward. The mounting plate 12 is inserted downward into the top of the foamed cotton head 2 and attached to the foamed cotton head 2, forming a framework for the foamed cotton head 2.

The mounting plate 12 is directly attached to the foam cotton head 2. The mounting plate 12 has a plurality of through holes 121 running transversely, or a plurality of recesses formed on the surface of the mounting plate 12.

The mounting plate 12 has a flange 122 extending transversely from the top of the mounting plate 12, the mounting plate 12 has a T-shaped cross-section; the joint portion 11, as an insertion joint, is connected to the middle of the flange 122 and extends upward from the top of the flange 122.

The joint portion 11 is hollow and oblate, and has an elastic clamping pin 111 on each of left and right sides.

The mounting member 1 having a joint portion 11 mounted on a mounting plate 12 extending downward; the mounting plate 12 is inserted downward into the top of the foamed cotton head 2 and attached to the foamed cotton head 2, forming a framework for the foamed cotton head 2. Accordingly, the whole foamed cotton head 2 is partially supported by the mounting plate 12, so that the foamed cotton head 2 is kept at certain strength, not floppy, and difficult to shake and deform during mopping. The mopping operation becomes easier, and the hand feeling is better. During the foamed cotton head 2 is squeezing, it is ensured that the surface of the foamed cotton head 2 are subjected to the squeezing force evenly and difficult to deform.

### Embodiment 2 of the Foamed Cotton Mop Head

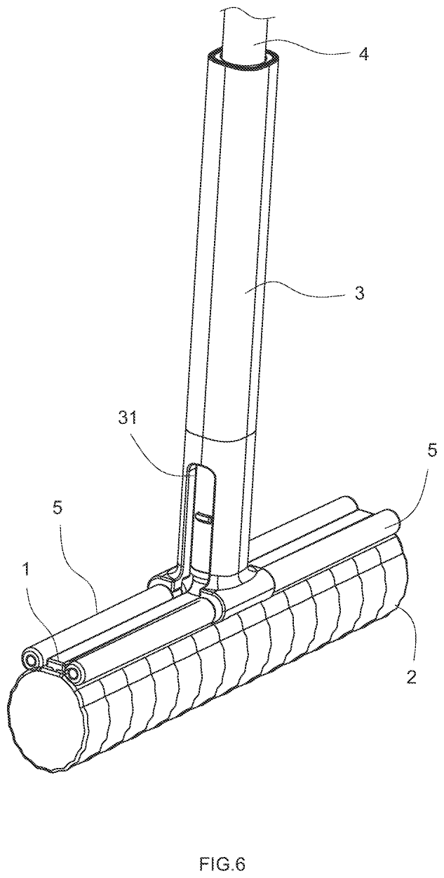

FIGS. 4 and 5 show a second embodiment of the foamed cotton mop head. The foamed cotton mop head of this embodiment differs from the above first embodiment in that, the foamed cotton head 2 has an insertion slot 21 extending downward from the top of the foamed cotton head 2; the mounting plate 12 is inserted into the insertion slot 21 and adhesively connected to the foamed cotton head 2;

Or, two sides of the foam cotton head 2 are folded upward from the bottom of the mounting portion 12 and extend to the surface of the mounting plate 12 to be adhesively connected with each other.

### Embodiment of the Mop

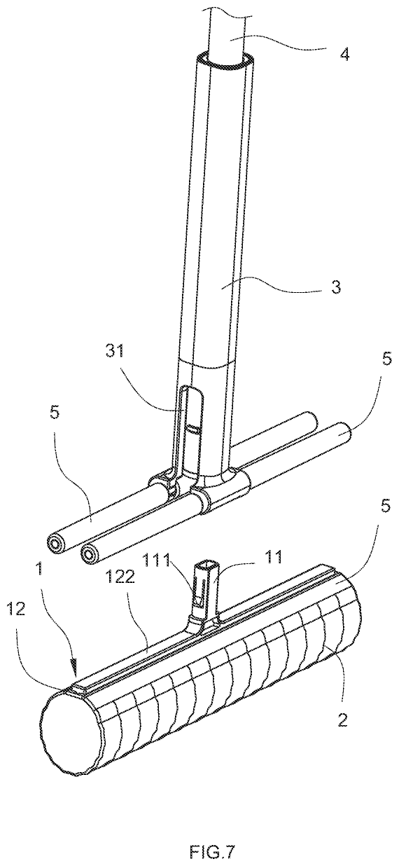

FIGS. 6 and 7 show a preferred embodiment of a mop of the present invention. The mop comprises a mop rod 4 and the above said foamed cotton mop head. The bottom of the mop rod 4 is connected to the joint portion 11. A water squeezing frame 3 capable of moving in its axial direction is also attached to the mop rod 4. The water squeezing frame 3 has a U-shaped elastic bayonet 31. Two water squeezing rods 5 are respectively disposed on each side of the bottom of the elastic bayonet 31. By directly pushing the water squeezing frame 3, the foamed cotton head 2 passes between the water squeezing rods 5 on two sides to realize water squeezing.

The joint portion 11 is detachably inserted into and connected to the bottom of the mop rod 4 in a buckling manner.

The foam cotton head 2 has two strip-shaped slopes 22 on the top of the foam cotton head 2, which are respectively located on the two sides of the mounting portion 12. After the water squeezing frame 3 is moved down, the water squeezing rods 5 squeeze the foam cotton head 2 downward along the slopes 22.

In this embodiment, the up-down direction refers to the length direction of the mop rod 4, the left-right direction refers to the length direction of the foldable mop head 2, and the front-rear direction refers to the width direction of the foldable mop head 2.

The operation principle and working process of the mop is as below.

Water squeezing operation: the water squeezing frame 3 is held by one hand of a user, and the mop rod 4 is held by the other hand; the water squeezing frame 3 is pulled to move down relative to the mop rod 4; the water squeezing rods 5 on two sides of the water squeezing frame 3 squeeze downward the slopes 22 of the foamed cotton head 2; and the foamed cotton mop head passes upward between the water squeezing rods 5 on two sides to realize water squeezing.

There is no handle connecting rod structure between the squeezing frame 3 and the mop rod 4, so that the structure of the mop of the embodiment is simpler. The whole foam cotton head 2 is partially supported by the mounting plate 12, so that the foamed cotton head is kept at certain strength, not floppy, and difficult to shake and deform during mopping. The mopping operation becomes easier, and the hand feeling is better. During the water squeezing, it is ensured that the front and rear sides of the foamed cotton head 2 are subjected to the squeezing force evenly and difficult to deform. In addition, it is easier for the foamed cotton head 2 to pass through the elastic bayonet 31 of the water squeezing frame 3.

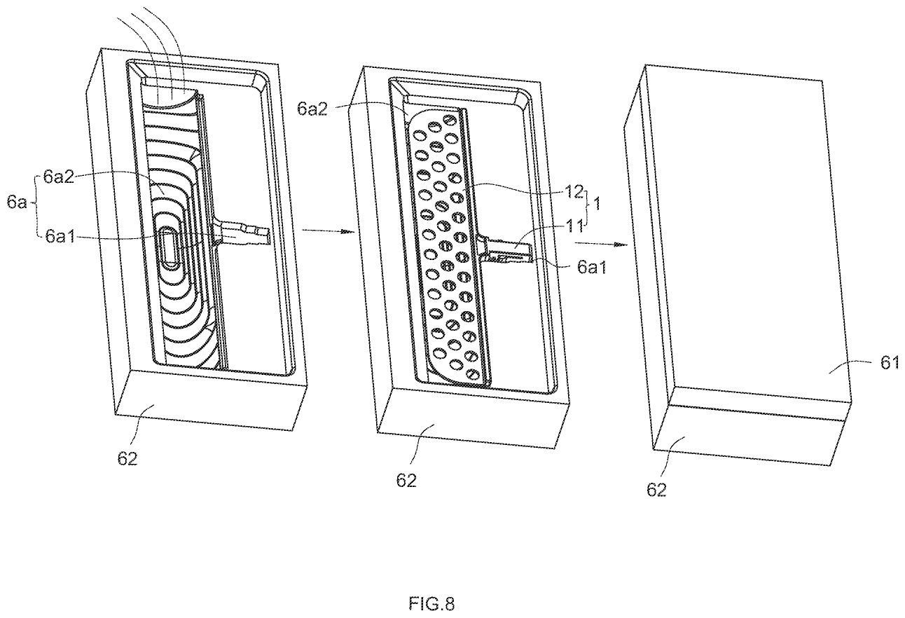

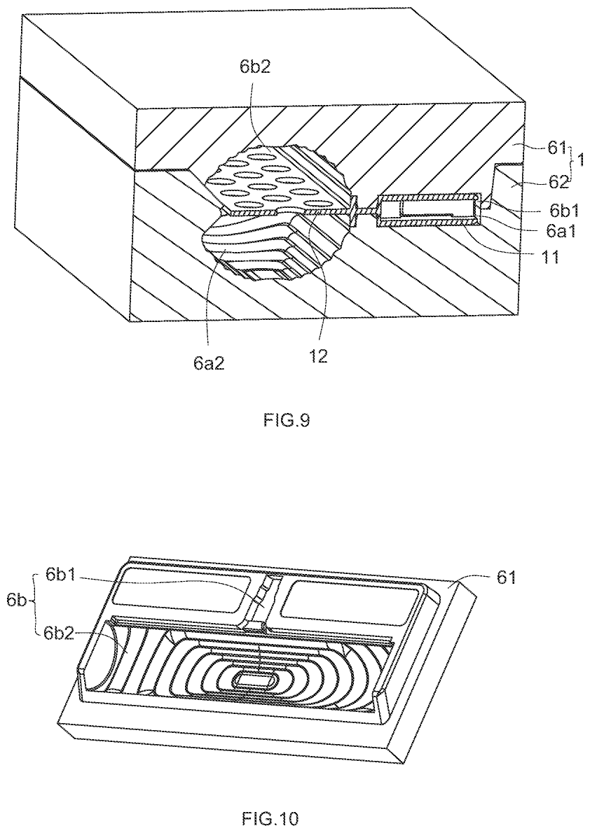

FIGS. 8-10 show a preferred embodiment of a manufacturing method of the foamed cotton mop head.

The manufacturing method comprises the following steps:
step-1, manufacturing the above said mounting member 1;
step-2, placing the mounting member 1 in a foaming die 6 as an insert, and pouring a polyurethane solution into the foaming die 6 and letting it stand, and then the polyurethane solution is foamed in the foaming die 6 to wrap the exterior of the mounting plate 12 of the mounting member 1 to form a foamed cotton head 2.

Finally, opening the foaming die, taking out the foamed cotton head, and removing the flash of the foamed cotton head 2.

In this embodiment, the foaming die 6 comprises an upper die 61 with an upper cavity 6b and a lower die 62 with a lower cavity 6a; the lower cavity 6a has a lower-half receiving chamber 6a1 for receiving the joint portion 11 and a lower foaming chamber 6a2 for foaming; the upper cavity 6b has an upper-half receiving chamber 6b1 for receiving the joint portion 11 and an upper foaming chamber 6b2 for foaming; after the upper die 61 and the lower die 62 are closed, the joint portion 11 is positioned within the space enclosed by the lower-half receiving chamber 6a1 and the upper-half receiving chamber 6b1, and the mounting plate 12 is located in the middle of the space enclosed by the lower foaming chamber 6a2 and the upper foaming chamber 6b2.

The detail operation of the foaming in the step-2 is as follows: pouring the polyurethane solution into the lower foaming chamber 6a2 and placing the mounting member 1 in the lower cavity 6a, and then closing the upper die 61 and letting it stand at last.

The mounting member is placed in the foaming die as an insert, and the polyurethane solution poured into the die is foamed in the die. The formed cotton head after foaming is wrapped with the mounting member to form one integrated mass, so that the foamed cotton head and the mounting member are attached very firmly, and the foamed cotton head is difficult to separate from the mounting member when in use. The conventional way of fixing the foamed cotton head to the mounting member by adhesion is discarded, and the use of glue is avoided. The foamed cotton mop head manufactured by this method is more environment-friendly, and avoids the damage to the human body caused by the use of glue. In addition, the manufacturing process is simpler, it is advantageous for mass production, and the cost is reduced.

It should be noted that in the description of this embodiment, the terms “front, back”, “left, right”, “up, down”, etc. indicate orientation or position relationships based on those shown in the attached drawings solely for the purpose of facilitating the description of the invention and simplifying the description, and do not indicate or imply that the device or element referred to must have a particular orientation, be constructed and operated in a particular orientation. Therefore, the protection scope of the present invention is not be limited to each embodiment described in this description. The verbs “disposed”, “attached” and “connected” should be understood in a broad sense. For example, they may be fixedly connected, detachably connected, integratedly connected, directly connected, indirectly connected through an intermediary, or connected within two components. For ordinary technical personnel in this field, the specific meaning of the above terms in the present invention can be understood in specific circumstances.

1. A foamed cotton mop head, comprising:
a mounting member having a joint portion mounted on a mounting plate extending downward;
a foamed cotton head mounted on the mounting member;
wherein,
the mounting plate is inserted downward into the top of the foamed cotton head and attached to the foamed cotton head, forming a framework for the foamed cotton head.

2. The foamed cotton mop head of claim 1, wherein the mounting plate is directly attached to the foam cotton head.

3. The foamed cotton mop head of claim 2, wherein the mounting plate has a plurality of through holes running transversely or a plurality of recesses formed on the surface of the mounting plate.

4. The foamed cotton mop head of claim 1, wherein the foamed cotton head has an insertion slot extending downward from the top of the foamed cotton head;
the mounting plate is inserted into the insertion slot and adhesively connected to the foamed cotton head.

5. The foamed cotton mop head of claim 1, wherein two sides of the foam cotton head are folded upward from the bottom of the mounting portion and extend to the surface of the mounting plate to be adhesively connected with each other.

6. The foamed cotton mop head of claim 1, wherein the mounting plate has a flange extending transversely from the top of the mounting plate, the mounting plate has a T-shaped cross-section;
the joint portion, as an insertion joint, is connected to the middle of the flange and extends upward from the top of the flange.

7. The foamed cotton mop head of claim 1, wherein the joint portion is hollow and oblate, and has an elastic clamping pin on each of left and right sides.

8. The foamed cotton mop head of claim 1, wherein the foam cotton head has two strip-shaped slopes on the top of the foam cotton head, which are respectively located on the two sides of the mounting portion.

9. A mop, comprising a mop rod;
the foamed cotton mop head of claim 1;
wherein, the bottom of the mop rod is connected to the joint portion.

10. The mop of claim 9, wherein the joint portion is detachably inserted into and connected to the bottom of the mop rod.

11. The method of manufacturing the foamed cotton mop head comprises the following steps:
step-1, manufacturing the mounting member of claim 1;
step-2, placing the mounting member in a foaming die as an insert, and pouring a polyurethane solution into the foaming die and letting it stand, and then the polyurethane solution is foamed in the foaming die to wrap the exterior of the mounting plate of the mounting member to form a foamed cotton head.

12. The method of claim 11, wherein the foaming die comprises an upper die with an upper cavity and a lower die with a lower cavity;
the lower cavity has a lower-half receiving chamber for receiving the joint portion and a lower foaming chamber for foaming;
the upper cavity as an upper-half receiving chamber for receiving the joint portion and an upper foaming chamber for foaming;
after the upper die and the lower die are closed, the joint portion is positioned within the space enclosed by the lower-half receiving chamber and the upper-half receiving chamber, and the mounting plate is located in the middle of the space enclosed by the lower foaming chamber and the upper foaming chamber.

13. The method of claim 12, wherein the detail operation of the foaming in the step-2 is as follows:
pouring the polyurethane solution into the lower foaming chamber and placing the mounting member in the lower cavity, and then closing the upper die and letting it stand at last.

14. The method of claim 12, wherein the upper die/the lower die has a pouring channel communicated with the upper foaming chamber/the lower forming chamber;
the detail operation of the foaming in the step-2 is as follows: placing the mounting member in the lower cavity and close the upper die and the lower die, and then pouring the polyurethane solution into the upper foaming chamber/the lower forming chamber through the pouring channel, and finally letting it stand and foam.

15. The method of claim 11, wherein the mounting member in the step-1 is:
a plastic member which is manufactured by an injection molding machine;
or a metal member manufactured by stamping;
or a cast manufactured by casting.
